(19) United States
(12) Patent Application Publication
(10) Pub. No.: US 2007/0181785 A1
(43) Pub. Date: Aug. 9, 2007

(54) Compact optical navigation module and microlens array therefore

(76) Inventors: Rene P. Helbing, Palo Alto, CA (US); Russell W. Gruhlke, Fort Collins, CO (US)

Correspondence Address: Kathy Manke;Avago Technologies Limited, 4380 Ziegler Road, Fort Collins, CO, 80525, US

(21) Appl. No.: 11/350,023

(22) Filed: Feb. 9, 2006

(51) Int. Cl. G06M 7/00

(52) U.S. Cl. 250/221

(57) ABSTRACT

An optical motion sensing module includes a microlens array comprising a plurality of lenslets, each lenslet forming a corresponding image of a surface; a light sensor comprising a plurality of pixels corresponding to the plurality of lenslets to detect the formed images of the surface; and a controller to use the detected images to determine a motion of the surface relative to the optical navigation module. The optical navigation module is usable in optical mice or in other applications in which relative motion is detected optically.

### BACKGROUND OF THE INVENTION

1. Field of the Invention

Aspects of the invention relate to an image motion sensor using a microlens array, and more particularly, to an optical navigation module using a flat type microlens array.

2. Description of the Related Art

Conventionally, optical navigation modules (i.e., computer mice) come in a wide variety of shapes having different features and sizes and prices. Computer mice are divided up according to how the motion is sensed. Specifically, optical mice use optical motion sensing. In contrast, mechanical mice use mechanical motion sensing. While the mechanical mice were the earlier of the two types of computer mice, the optical mice have begun to gain increased acceptance.

Early versions of optical mice relied upon fine lines on a specific grid in order to perform tracking operations. However, with the advent of an optical position sensor by Agilent Technologies in 1999, optical mice are now able to work on a wide variety of surfaces without requiring the fine line grids. The optical position sensor works by taking a picture of the surface on which the mouse is navigating, and comparing images taken sequentially to detect the speed and direction of the movement of the surface relative to the mouse. In this manner, the optical mouse is able to navigate across a wide variety of surfaces without requiring such a grid.

In contrast to early optical mice and mechanical mice which used a ball to perform the tracking operation, an optical mouse typically does not use a ball. Specifically, the mouse includes a clear lens underneath. Light from a light source (generally an LED emitting a red wavelength light) reflects off the surface and is received through a window at the lens. The lens focuses the received light on a sensor, which detects the image. As such, as the mouse is moved, the sensor takes continuous images of the surface and compares the images to determine the distance and direction traveled utilizing digital signal processing. The results are then sent to the computer or other computational device in order to move the cursor on the screen.

Such transmission to the computer can be either directly through a cord, which often supplies energy for use in powering the mouse, or using a cordless mouse, which uses RF technology or Bluetooth in order to transmit the navigational data to the computer. Where a cordless optical mouse is used, an onboard power source such as a battery is used in order to power a light source and a sensor of the mouse.

However, the conventional lens used in an optical mouse is a single lens. The single lens requires an increased focal length and has a thickness which increases the thickness/form factor of the resulting mouse. Moreover, the single lens is fabricated by injection molding and is then joined together with separate components, such as the sensor, which increases the fabrication costs.

Other lenses or lens arrays have been used and described in the past in the context of imaging for human consumption, such as for cameras and/or large screen displays. For example, WO 00/64146 describes a lens array used for conventional imaging for human consumption. However, due to problems with optical cross talk and ghosting caused when light from one lenslet is focused on an incorrect sensor pixel, such lens arrays need to perform trade offs between image quality and light sensitivity in order to have high quality images with respect to color, sharpness, and contrast. Additionally, in order to prevent image distortion, there needs to be a highly accurate alignment between the pixels and the corresponding lens as well as complex blocking structures to prevent ghost images and other effects of optical cross talk between pixels. Thus, the thrust of investigation into microlens arrays has been to resolve these problems in order to make microlens arrays useful for cameras. There has been no suggestion of the use of such arrays in other contexts, such as in the context of optical navigation modules.

### SUMMARY OF THE INVENTION

Aspects of the invention relate to a motion sensing apparatus utilizing a microlens lens array to performing imaging, and more particularly, to utilizing a microlens array.

Additional aspects and/or advantages of the invention will be set forth in part in the description which follows and, in part, will be obvious from the description, or may be learned by practice of the invention.

According to an aspect of the invention, an optical motion sensing module includes a microlens array comprising a plurality of lenslets, each lenslet forming a corresponding image of a surface; a light sensor comprising a plurality of pixels corresponding to the plurality of lenslets to detect the formed images of the surface; and a controller to use the detected images to determine a motion of the surface relative to the optical navigation module.

According to an aspect of the invention, the optical motion sensing module further includes a light source to direct light at the surface, wherein the microlens array forms the images of the surface using the light reflected from the surface.

According to an aspect of the invention, the microlens array is disposed less than 10 mm from the surface.

According to an aspect of the invention, the microlens array is bonded to the light sensor.

According to an aspect of the invention, the microlens array further comprises an aperture for each lenslet to prevent optical cross talk at the pixels between adjacent images formed by adjacent lenslets.

According to an aspect of the invention, the microlens array has a rectangular shape such that the lenslets extend in parallel.

According to an aspect of the invention, the microlens array has a curved shape such that the lenslets extend in circumferentially around at least one center.

According to an aspect of the invention, the microlens array has a circular shape such that the lenslets extend circumferentially around the center of the circular shape.

According to an aspect of the invention, the microlens array has an elliptical shape such that the lenslets extend circumferentially around the centers of the elliptical shape.

According to an aspect of the invention, the optical motion sensing module includes a light source to emit light used by the microlens array to form the images, wherein the light sensor is disposed on a surface with the light source.

According to an aspect of the invention, the light source further comprises a light guide surrounding at least one of the pixels of the light sensor, and a light emitter to emit light into the light guide such that the light guide guides the light to reach the surface.

According to an aspect of the invention, the optical motion sensing module includes a light source to emit light used by the microlens array to form the images, wherein the light sensor includes a layer of light emitting material.

According to an aspect of the invention, each lenslet forms the corresponding image of the surface on the corresponding pixel at a corresponding offset from a centerline of the lenslet, and an amount of the offset varies as a function of distance from an edge of the light sensor.

According to an aspect of the invention, the offset increases as a function of distance from a center of the light sensor toward an edge of the light sensor.

According to an aspect of the invention, the microlens array further comprises an aperture system which prevents multiple images from non-corresponding lenslets from being formed on a same pixel.

According to an aspect of the invention, each lenslet has a diameter in a range at or between 5 to 200 microns, and a height of the microlens array is in a range at or between 5 to 500 microns.

According to an aspect of the invention, each lenslet corresponding to one of the pixels, and a number of pixels of the light sensor is in a range at or between 50 to 2,000 pixels.

According to an aspect of the invention, a computer mouse for use in navigation on a surface includes a base having a window through which light reflected from the surface passes; a body on top of the base plate forming an interior cavity with respect to the base; a microlens array disposed in the cavity and having a plurality of lenslets which receive the light from the window and form a corresponding number of images at varying offsets on a focal plane; a sensor disposed in the cavity and having a plurality of pixels disposed at the focal plane and which detect the formed images; and a controller disposed in the cavity and which detects motion of the mouse relative to the surface according to the detected images of the sensor and transmits the detected motion to an associated device.

According to an aspect of the invention, the sensor is a CMOS sensor.

According to an aspect of the invention, the computer mouse further comprising includes a light source within the cavity which produces the light to be reflected off the surface and received at the microlens array after passing through the window, wherein the light source is disposed relative to the microlens array such that an illumination field of the light on the surface corresponds to a field of view of the microlens array to reduce optical cross talk.

According to an aspect of the invention, the body allows ambient light to reflect off the surface and received at the microlens array after passing through the window.

According to an aspect of the invention, the microlens array further comprises an aperture system which prevents multiple images from non-corresponding lenslets from being formed on a same pixel.

According to an aspect of the invention, each lenslet corresponds to one of the pixels, and the number of pixels is in a range at or between 50 to 2,000 pixels.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a profile view of an optical navigation module utilizing a microlens lens array according to an embodiment of the invention;

FIG. 2 is a schematic view of the microlens array and LED shown in FIG. 1 according to an aspect of the invention;

FIG. 3A is an example of a microlens array with an offset between lenslets and the corresponding pixels and utilizing apertures according to an aspect of the invention;

FIG. 3B is an example of a microlens array without an offset between lenslets and the corresponding pixels according to an aspect of the invention;

FIG. 4 is an example of a microlens array without using a set of apertures according to an aspect of the invention;

FIG. 5 is an example of a circular lens array shown in FIGS. 3 and 4 cut across cross-section AA according to an aspect of the invention;

FIGS. 6A and 6B shown an example of a light source integrated on a periphery of the sensor according to an aspect of the invention;

FIGS. 7A and 7B shown an example of a light source integrated on between pixels of the sensor according to an aspect of the invention; and

FIG. 8 shows an example of a light source not using a light guide according to an aspect of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

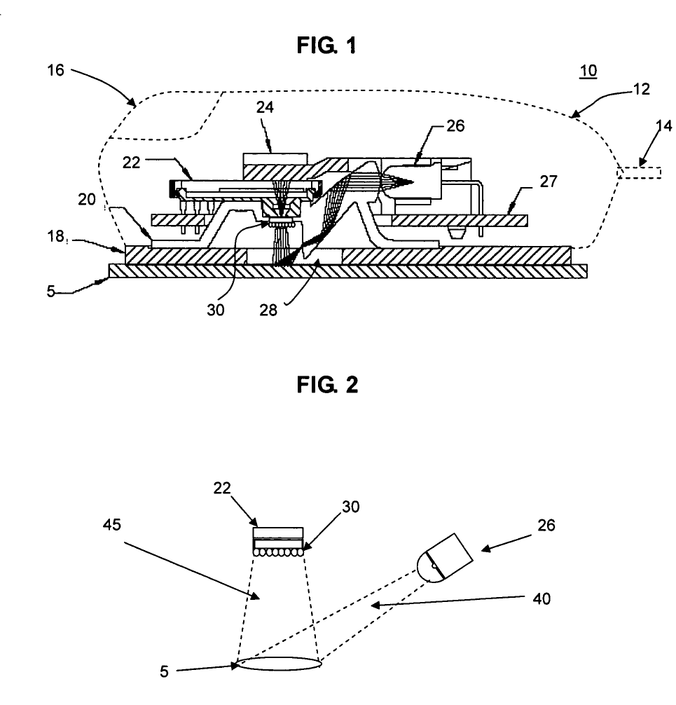

FIG. 1 shows an example of an optical navigation module according to an aspect of the invention. As shown, the optical navigation module corresponds to a mouse 10. The mouse 10 rests on and moves relative to a surface 5. The mouse 10 includes a body 12 on top of a base plate 18. The body 12 is generally shaped to fit in the palm of a hand, and is often ergonomically shaped. The body 12 further may be opaque according to an aspect of the invention. Alternately, the body 12 may be translucent in order to allow light to pass to the surface in order to be used to perform optical navigation according to an aspect of the invention.

Extending from the body 12 is a cord 14. The cord 14 transfers power and/or detected direction signals with respect to a computer or other device (not shown) to which the optical navigation module is connected. However, it is understood that the cord 14 may be replaced by a transmitter for a wireless mouse 10, and/or that power may be internally supplied instead of being transferred from a computational device.

On top of the body 12 is a button or button array 16. The button array 16 is used by a user to input signals, such as by clicking. However, it is understood that a button 16 is not required in all aspects of the invention, and it is possible to input signals through other mechanisms, as in the case of game controllers, or to integrate the button into the connection between the body 12 and the base 18 to input signals by pressing the body 12.

The mouse 10 includes an internal kit used to detect motion due to relative motion of reflected light as detected by comparing images. As shown in FIG. 1, the kit generally corresponds to the Agilent ADNK-2133 optical mouse designer's kit (as described in the Agilent ADNK-2133 Optical Mouse Designer's Kit Product Overview), the disclosure which is incorporated herein by reference. However, it is understood that other types of kits (such as that described in the Agilent ADNK-3043-ND24 USB 2.4GHz RF Wireless Low-Power Mouse Designer's Kit Product Over, the disclosure of which is incorporated by reference) can be used according to aspects of the invention.

A light source 26 outputs a light beam which is reflected through a lens pipe 20 to be reflected off of the surface 5 through an opening in the base plate 18. The reflected light passes through a window 28 in the base plate and is received at a microlens lens array 30 according to an aspect of the invention. Specifically, the light is focused by the microlens array 30 onto a sensor 22 to produce multiple images of the surface 5. The sensor 22 can be a conventional CMOS image sensor or a CCD sensor according to aspects of the invention.

The image detected at the sensor 22 is detected by a chip 24. The chip 24 performs a comparative analysis over time of successive images in order to determine a direction and speed of the movement of the mouse 10. Specifically, the chip 24 includes firmware which compares present images detected by the pixels 61-67 of the sensor 22 with images taken at a previous time, and the difference reveals the relative motion of the mouse 10 to the surface 5. The resulting output is output through the cord 14 using a PCB 27. However, it is understood that various elements of the shown mouse 10 need not be used in all aspects of the invention. For example, the use of the light pipe 20 need not be used and/or the use of an LED as the light source 26 can be replaced by other light sources.

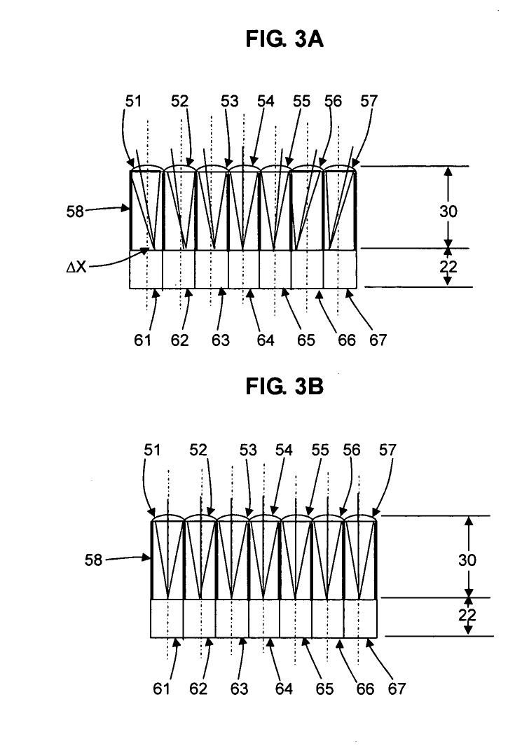

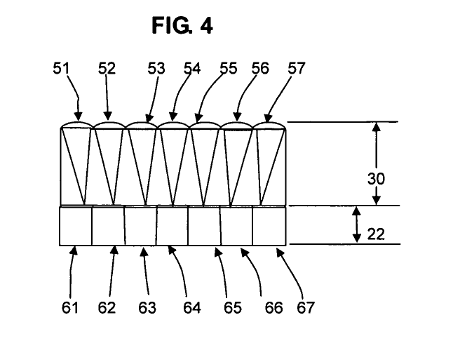

While existing optical mice use a similar construction for many of the parts, the conventional optical mouse includes a single objective lens focusing an image onto a sensor as a single image. In contrast, as shown in FIGS. 3A through 4, the microlens array 30 (alternately referred to as a flat lens array) has a plurality of lenslets 51-57, each of which focuses individual images onto corresponding pixels 61-67 of the sensor 22. This allows the lens array 30 to be placed closer to the surface 5, thereby reducing the form factor (i.e., physical size) of the overall mouse 10. As shown in FIG. 2, the microlens array 30 is designed to be close to the sensor 22. While not required in all aspects, the microlens array 30 can be layered on and/or bonded to the sensor 22 so as to further decrease the form factor. The lens array 30 is designed such that the field of view 45 of the lens array matches the illumination field 40 produced by the light source 26. However, it is understood that the light source 26 need not be used in all aspects of the invention, such as where ambient light is used to perform optical mouse navigation.

FIG. 3A shows an embodiment of the invention in which the microlens array 30 includes apertures 58. As shown, the microlens array 30 includes lenslets 51 through 57. As can be seen in FIG. 3A, light entering each lenslet is focused at a different angle, and therefore has an offset Δx when reaching the corresponding pixel 61 through 67 of the sensor 22. Specifically, the lenslet 51 focuses light to form an image onto pixel 61, lenslet 52 focuses light to form an image onto pixel 62 but at a different offset Δx. Lenslet 53 focuses light to form an image onto pixel 63, and lenslet 54 focuses light to form an image onto pixel 64. As shown, light focused by lenslet 54 travels parallel to the center line of the lens array 30, and therefore has no offset Δx. Lenslet 55 focuses light to form an image at an offset Δx onto pixel 65, lenslet 56 focuses light to form an image onto pixel 66, and lenslet 57 focuses light to form an image at an increased offset Δx onto pixel 67. Using these offsets, the microlens array 30 steers each image to a corresponding location chosen to reduce or prevent cross talk between pixels. The images from the surface 5 are transmitted from each of the pixels 61 through 67, which make up the sensor 22, to the chip 24. The chip 24 performs a conventional image correlation process, an example of which is found in U.S. Pat. No. 5,644,139, the disclosure which is incorporated by reference.

The use of the aperture 58 is used to prevent ghost images to provide an increased contrast and sharpness of the image of the surface 5. Ghost images occur when light from one lenslet reaches an adjacent pixel, thereby creating a false image at that adjacent pixel. By controlling the illumination field 40 through placement of the light source 26 and using the aperture 58, the ghosting and cross talk can be reduced. Moreover, since the existence of ghost images is not fatal in the context of optical motion sensing, the aperture 58 need not be used even where the light source 26 is not used to control the illumination field 40 (such as when using ambient light). However, the use of the aperture 58 and/or the light source 26, along or in combination, is preferred in order to provide a higher contrast image and improve the image motion detection.

However, it is understood that, while shown in FIG. 3A, there need not be offsets in all aspects of the invention. Specifically, for small distances between the surface 5 and the microlens array 30, there is less overlap between images formed by the microlens array 30. Thus, for a mouse 10 having a distance between the surface 5 and the microlens array 30 of roughly 1 millimeter, there would not be appreciable overlap and offset would not be needed. In contrast, where the distance between the surface 5 and the microlens array 30 is 3 millimeters, there would be image overlap and some mechanism, such as an offset or an aperture, is more desirable to use in order to improve performance. The distance at which overlap occurs can be other than 3 millimeters depending on the design of the microlens array 30.

An example of such an embodiment is shown in FIG. 3B in which the microlens array 30 includes lenslets 51 through 57 which do not have offset. Specifically, each lenslet 51 through 57 focuses the corresponding light along the centerline of the corresponding lenslet 51 through 57 onto the corresponding pixel 61 through 67 of the sensor 22. Specifically, the lenslet 51 focuses light to form an image onto pixel 61, lenslet 52 focuses light to form an image onto pixel 62, lenslet 53 focuses light to form an image onto pixel 63, tenslet 54 focuses light to form an image onto pixel 64, lenslet 55 focuses light to form an image onto pixel 65, lenslet 56 focuses light to form an image onto pixel 66, and lenslet 57 focuses light to form an image onto pixel 67. The images from the surface 5 are transmitted from each of the pixels 61 through 67, which make up the sensor 22, to the chip 24. The chip 24 performs a conventional image correlation process, an example of which is found in U.S. Pat. No. 5,644,139, the disclosure which is incorporated by reference.

According to an aspect of the invention, where no offset is used, in order to prevent overlap and ghost images, the field of view of each lenslet is reduced in relation to a distance between the surface 5 and the microlens array 30 since, the greater the distance, the greater likelihood of overlap. Thus, the field of view of each lenslet is directed at a small angle so that the field of view of one lens does not overlap substantially with a field of view of an adjacent lenslet. While shown as focusing light along the centerline, it is understood that each lenslet could focus light at a same angle according to another aspect of the invention.

Where ghosting of the images is of lesser importance, such as where the light source 26 is focused at a preset angle onto the surface 5, the aperture 58 need not be used as shown in FIG. 4. Moreover, the use of the aperture 58 need not be used in all aspects of the invention since the preventing ghost images (i.e., the cross-over of an image focused from one lens to another pixel) is of lesser importance when a comparison is being made of successive images as compared to when the imaging by the microlens is being done for human consumption.

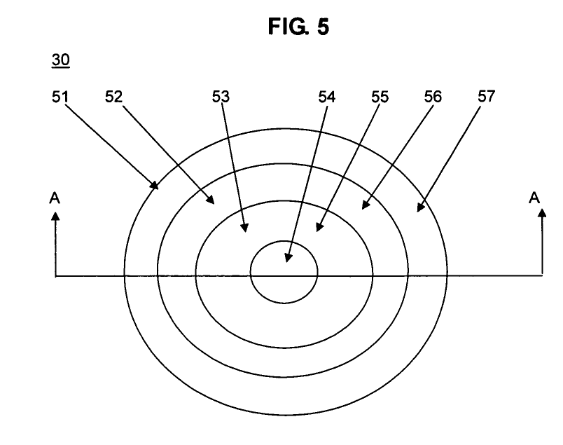

While many different shapes of the microlens array 30 are possible, FIG. 5 shows a circular embodiment of the microlens array 30 in which the lenses 51-57 shown in FIGS. 3 and 4 correspond to lower concentric circles. The views in FIGS. 3 and 4 are cross-sectional views taken across A-A. However, it is understood that the array 30 can also be rectilinear or other shapes according to aspects of the invention.

While use in existing optical navigation modules is possible since the illuminated surface 5 are a few tens of centimeters from the microlens array 30, the microlens array 30 allows for smaller distances between the surface 5 and the microlens array 30. Such smaller distances are on the order of a few millimeters, making for a small form factor. Preferably, for a small form factor, the distance from the microlens array 30 to the surface 5 is less than three millimeters. As such, the microlens array could be used in travel applications, such as for providing optical navigation for smaller portable electronic devices like cell phones and personal digital assistants.

Moreover, whereas existing uses of lens arrays, such as that shown in PCT Publication WO 00/64146 in FIGS. 1 and 2 as well as lenticular lenses exist and are usable in aspects of the present invention, these existing lens arrays require extensive effort to prevent ghosting and cross-over of the images, which makes these lens arrays less desirable for use even for human consumption. By way of example, the lens array of PCT Publication WO 00/64146 requires the use of an offset in order to produce an image suitable for a camera. In contrast, the microlens array 30 according to aspects of the present invention is used for optical navigation and/or optical motion sensors and does not need such a precise image. Further the microlens array 30 has a nearly zero angle field of view, and is thus able to image the entire illumination field 40. This ability simplifies the alignment of the lenslets 51 through 57 with any aperture array 58 so as to reduce fabrication costs. While not required in all aspects of the invention, the microlens array 30 has a thickness in a range between a few microns to a few hundred microns thick. According to an aspect of the invention, the diameter of each lenslet 51 through 57 is on the order of 5 to 200 microns, and a height of the microlens array 300 is in a range at or between 5 to 500 microns.

Additionally, while the microlens array 30 can be separately attached and/or have a layer between the array 30 and the sensor 22, the microlens array 30 may be bonded directly to the sensor 22 according to an aspect of the invention. Such direct bonding would allow for reduced fabrication cost, greater ease in pixel-lenslet alignment, and a lower form factor as compared to conventional lenses. The microlens array 30 can be fabricated using any optical material normally used for lenses. By way of example, glass, plastic or a plastic photoresist may be used according to an aspect of the invention. Specifically, the photoresist can be used at a wafer level scale by forming the lenses 51-57 through a resist reflow process.

In the resist reflow process, the resist is placed on a wafer, the resist is lithographically patterned to correspond to the pixel layout, and then heat is generated in order to reflow the resist to form the individual lenses 51 through 57 through surface tension. Alternately, an optical material can be formed into the microlens array 30 through processes such as injection molding, preferably at wafer level.

While seven lenslets 51 through 57 are shown in FIGS. 3 and 4 for simplicity, it is understood for a mouse 10 that additional lenslets detectors often will be needed. Specifically, for a one lenslet per pixel embodiment, a mouse 10 may use between 10×10 or 30×30 pixels in an array according to aspects of the invention. As such, a corresponding number of lenslets would be used. However, it is understood that for other applications and/or for other mice, the pixel array of the sensor 22 can be between 50 to 2,000 pixels. As such, a corresponding number of lenslets would be needed for the microlens array 30. Moreover, while a one-to-one pixel to lenslet arrangement is described, it is understood that other ratios can be used in other aspects of the invention.

According to an aspect of the invention, the light source 26 can be an LED or other like light emitting device. According to an aspect of the invention, the light source 26 is a laser which produces interference patterns due to features of the surface. The interference patterns are imaged by the microlens array 30 to detect motion.

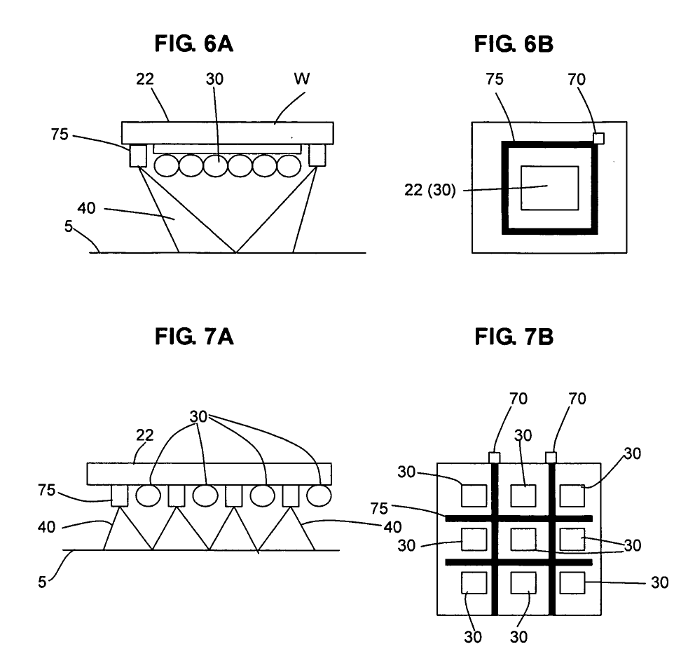

Additionally, while shown in FIGS. 1 and 2 as being separate from the sensor 22, it is understood that the light source 26 can be integrated with the sensor 22 in order to further reduce the form factor and the thickness of the optical navigation device. Moreover, such integration improves alignment between the fields 40, 45 so as to reduce optical cross talk, decreases the manufacturing costs and eliminates the need for elements such as the light pipe 20. Such integration can be performed using semiconductor and/or lithography techniques. Examples of such integrated light sources 26 and sensors 22 are shown in FIGS. 6A through 8.

FIG. 6A shows a cross sectional view of the integrated light source shown in FIG. 6B. As shown in FIGS. 6A and 6B, the light source 26 is included on a wafer W holding the sensor 22 and the microlens array 30. The light source 26 inputs a light input 70 and a light guide 75. The light input 70 emits light into the light guide 75, which is disposed on a periphery of the sensor 22. In this manner, the light guide 75 and light input 70 are disposed in an area normally used for circuitry and not required for receiving images. The light input 70 can be an LED or laser according to an aspect of the invention. The light guide 75 guides the input light to illuminate the surface 5. It is understood that, while only one light input 70 is shown and is disposed at a corner of the light guide 75, multiple light inputs can be used and/or can be otherwise located.

Alternately, as shown in FIGS. 7A and 7B, the light source 26 can be between pixels of the sensor 22 according to an aspect of the invention. FIG. 7A shows a cross sectional view of the integrated light source shown in FIG. 7B. Specifically, the light input 70 inputs light into a light guide shaped as a cross hatched matrix so as to emit light between the lenslets-pixel pairs. While shown as being between discrete lenslets so as to emit light between the lenslets, it is understood that the light guide 75, could instead send light at least partially through the lenslets. Further, it is understood that the light guide 75 can have other shapes, need not form a cross hatch pattern, and need not pass between each adjacent pair of pixels as shown.

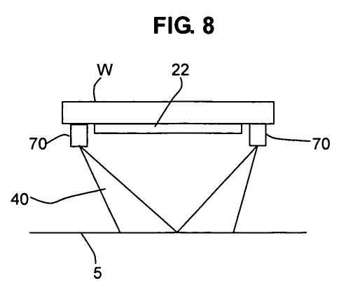

FIG. 8 shows an example of a light source 26 not using a light guide according to an aspect of the invention. Specifically, in FIG. 8, only light inputs 70 are used. However, the use of the light guides 75 allows the light to be emitted from a point closer to the surface 5 as compared to the examples shown in FIGS. 2 and 8.

While shown in FIGS. 6A through 8 as using separate light input 70 and light guides 75, it is understood that the shown patterns can be replaced with light emitting layers, such as those used in organic electroluminescent displays (OELDs) and organic light-emitting diodes (OLEDs). In this manner, strips of light emitting material can be deposited between pixels and/or around pixels to provide the light without increasing a distance between the microlens array 30 and the surface 5 and/or increasing a form factor of the mouse 10 or other like optical motion sensing module.

While described in the context of optical navigation modules, it is understood that aspects of the present invention can be used in general motion sensing where image quality is not of paramount importance. As such, the microlens array of the present invention can be used in the context of thin optical security motion sensors by detecting relative image motions. Similarly, the microlens array can be used in proximity sensors, and/or scanners. Also the microlens lens array can also be implemented in the context of an image stabilization system, such as is used in a camcorder or other like camera.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical motion sensing module comprising:
a microlens array comprising a plurality of lenslets, each lenslet forming a corresponding image of a surface;
a light sensor comprising a plurality of pixels, each pixel corresponding uniquely to one of the plurality of lenslets, to detect the formed images of the surface; and
a controller to use the detected images to determine a motion of the surface relative to the optical navigation module.

2. The optical motion sensing module of claim 1, further comprising a light source to direct light at the surface, wherein the microlens array forms the images of the surface using the light reflected from the surface.

3. The optical motion sensing module of claim 1, further comprising a laser to direct light at the surface, wherein the microlens array forms the images of interference patterns formed on the surface using the light.

4. The optical motion sensing module of claim 1, wherein the microlens array is disposed less than 10 mm from the surface.

5. The optical motion sensing module of claim 1, wherein the microlens array is bonded to the light sensor.

6. The optical motion sensing module of claim 1, wherein the microlens array further comprises an aperture system which prevents multiple images from non-corresponding lenslets from being formed on a same pixel.

7. The optical motion sensing module of claim 1, wherein each lenslet forms the corresponding image of the surface on the corresponding pixel at a corresponding offset from a centerline of the lenslet, and an amount of the offset varies as a function of distance from an edge of the light sensor.

8. The optical motion sensing module of claim 7, wherein the offset increases as a function of distance from a center of the light sensor toward an edge of the light sensor.

9. The optical motion sensing module of claim 7, wherein the microlens array further comprises an aperture system which prevents multiple images from non-corresponding lenslets from being formed on a same pixel.

10. The optical motion sensing module of claim 7, wherein each lenslet has a diameter, the diameter is in a range at or between 5 to 200 microns, and a height of the microlens array is in a range at or between 5 to 500 microns.

11. The optical motion sensing module of claim 7, wherein each lenslet corresponds to one of the pixels, and a number of pixels of the light sensor is in a range at or between 50 to 2,000 pixels.

12. The optical motion sensing module of claim 1, further comprising a light source to emit light used by the microlens array to form the images, wherein the light sensor is disposed on a surface with the light source.

13. The optical motion sensing module of claim 12, wherein the light source further comprises a light guide surrounding at least one of the pixels of the light sensor, and a light emitter to emit light into the light guide such that the light guide guides the light to reach the surface.

14. The optical motion sensing module of claim 1, further comprising a light source to emit light used by the microlens array to form the images, wherein the light sensor includes a layer of light emitting material.

15. A computer mouse for use in navigation on a surface, comprising:
a base having a window through which light reflected from the surface passes;
a body on top of the base plate forming an interior cavity with respect to the base;
a microlens array disposed in the cavity and having a plurality of lenslets which receive the light from the window and form a corresponding number of images at varying offsets on a focal plane;
a sensor disposed in the cavity and having a plurality of pixels disposed at the focal plane which detect the formed images; and
a controller disposed in the cavity and which detects motion of the mouse relative to the surface according to the detected images of the sensor.

16. The computer mouse of claim 15, wherein the sensor is a CMOS sensor.

17. The computer mouse of claim 15, further comprising a light source within the cavity which produces the light to be reflected from the surface and received at the microlens array after passing through the window, wherein the light source is disposed relative to the microlens array such that an illumination field of the light on the surface corresponds to a field of view of the microlens array to reduce optical cross talk.

18. The computer mouse of claim 15, wherein the body allows ambient light to reflect off the surface and be received at the microlens array after passing through the window.

19. The computer mouse of claim 15, wherein the microlens array further comprises an aperture system which prevents multiple images from non-corresponding lenslets from being formed on a same pixel.

20. The computer mouse of claim 15, wherein each lenslet corresponds to one of the pixels, and a number of pixels is in a range at or between 50 to 2,000 pixels.
